(19) United States
(12) Patent Application Publication
(10) Pub. No.: US 2014/0317371 A1
(43) Pub. Date: Oct. 23, 2014

(54) METHOD AND SYSTEM FOR ACCESS BASED DIRECTORY ENUMERATION

(71) Applicant: NETAPP, INC., Sunnyvale, CA (US)

(72) Inventors: Mark Muhlestein, Sunnyvale, CA (US); Shekhar Amlekar, Bangalore (IN)

(73) Assignee: NETAPP, INC., Sunnyvale, CA (US)

(21) Appl. No.: 13/866,281

(22) Filed: Apr. 19, 2013

(51) Int. Cl. G06F 12/14

(52) U.S. Cl. CPC G06F 12/1458
USPC 711/163

(57) ABSTRACT

Method and system for access based directory enumeration is provided. When a directory is enumerated for a first time, user credentials are verified against an access control list (ACL) entry that is referenced by an ACL inode (referred to as Xnode). The Xnode number is obtained from a file handle for a directory entry. The verification is recorded in a data structure that stores the Xnode identifier and user identifier. When the directory is enumerated again, the data structure is used to verify that the user has been validated before, instead of loading and checking against an ACL entry.

### BACKGROUND

1. Technical Field

The present disclosure relates to storage systems in general and to access based directory enumeration in particular.

2. Related Art

A storage system typically comprises one or more storage devices where information may be entered, and from which information may be obtained, as desired. The storage system typically includes a storage operating system that functionally organizes the system by, inter alia, invoking storage operations in support of a storage service implemented by the system. The storage system may be implemented in accordance with a variety of storage architectures including, but not limited to, a network-attached storage environment, a storage area network and a storage device directly attached to a user or host computer. Storage of information is preferably implemented as one or more storage “volumes” of physical storage devices, defining an overall logical arrangement of storage space

Storage systems often have to store millions of directory entries to implement a hierarchical organization of data stored with respect to the storage volumes. A user may want to enumerate directory entries using an access control methodology, referred to as access based enumeration (ABE). Under ABE, only directory entries that a user is permitted to access are provided to the user. Verifying user permissions for each directory entry can consume computing resources, especially when the storage system may store millions of directory entries. Continuous efforts are being made to efficiently perform ABE.

### BRIEF DESCRIPTION OF THE DRAWINGS

The foregoing features and other features will now be described with reference to the drawings of the various embodiments. In the drawings, the same components have the same reference numerals. The illustrated embodiments are intended to illustrate, but not to limit the present disclosure. The drawings include the following Figures:

FIG. 1 shows a block diagram of a network storage system using the methodology of the present disclosure;

FIG. 2 shows an example of an operating system used by a storage system of FIG. 1;

FIG. 3 shows a block diagram on an inode structure used by an operating system of a storage system;

FIG. 4A shows a hierarchical inode structure used according to one embodiment of the present disclosure;

FIG. 4B shows the relationship between inodes and Xnodes, used according to one embodiment;

FIG. 5 shows an example of an access control list entry, according to one embodiment;

FIG. 6 is an example of a data structure used for access based directory enumeration, according to one embodiment;

FIG. 7 shows an example of a directory entry, according to one embodiment; and

FIG. 8 shows a process for access based directory enumeration, according to one embodiment.

### DETAILED DESCRIPTION

As a preliminary note, the terms “component” “module”, “system,” and the like as used in this disclosure are intended to refer to a computer-related entity, either software, hardware, a combination of hardware and software, or software in execution. For example, a component may be, but is not limited to being, a process running on a hardware based processor, a hardware based processor, an object, an executable, a thread of execution, a program, and/or a computer.

By way of illustration, both an application running on a server and the server can be a component. One or more components may reside within a process and/or thread of execution and a component may be localized on one computer and/or distributed between two or more computers. Also, these components can execute from various non-transitory computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other device, in accordance with the claimed subject matter.

In one embodiment, a method and system for access based directory enumeration is provided. When a directory is enumerated for a first time, user credentials are first verified against an access control list (ACL) that is referenced by an ACL inode (referred to as Xnode). The Xnode number is obtained from a file handle for a directory entry. The verification is recorded in a data structure that also stores the Xnode identifier and a user identifier. When the directory is enumerated again, instead of loading the ACL entry, the data structure is used to determine if the user has already been validated. Thus, ABE is performed without having to load ACL entries and verifying user credentials every time a directory is enumerated.

To facilitate an understanding of the various embodiments of the present disclosure, the general architecture and operation of a networked storage system will first be described. The specific architecture and operation of the various embodiments will then be described with reference to the general architecture.

System 100:

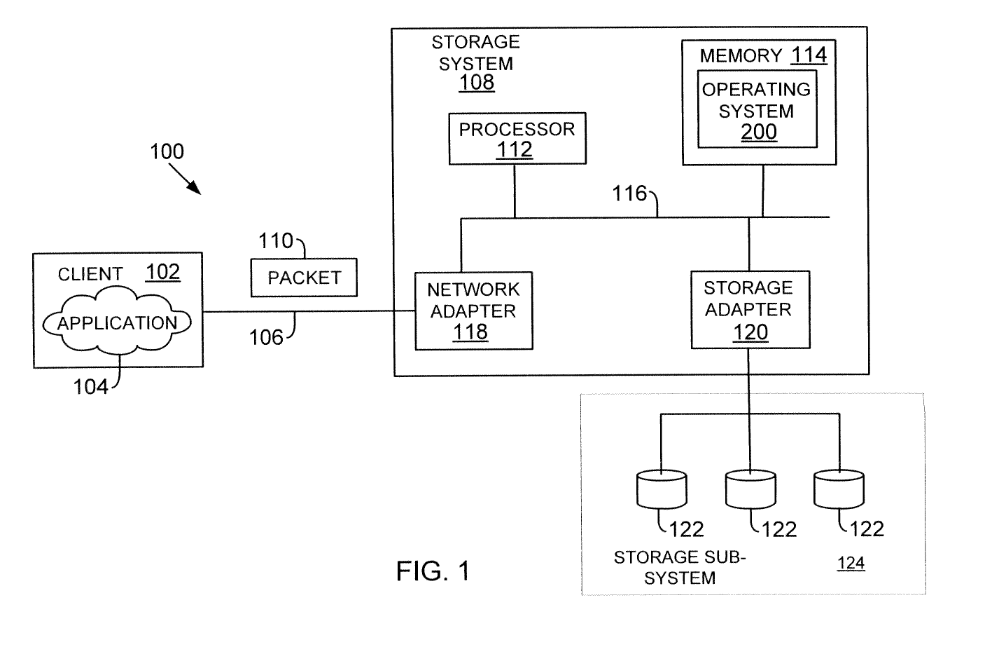

FIG. 1 is a schematic block diagram of an operating environment 100 (may also be referred to as system 100) having a storage system 108 (may also be referred to as storage server) that may be advantageously used with the present disclosure. Storage system 108 is used to store one or more data containers, for example, directories, files, structured and unstructured data. It is noteworthy that the term data container as used throughout this specification includes a file, a directory, or structured and unstructured data.

The storage system 108 may be one or more computing system that provides storage services relating to organization of information at mass storage devices, such as storage devices 122 of a storage sub-system 124. Storage devices 122 may be, for example, tape drives, conventional magnetic disks, optical disks such as CD-ROM or DVD based storage, magneto-optical (MO) storage, flash memory storage device or any other type of storage device suitable for storing structured and unstructured data. Some of the examples disclosed herein may reference a storage device as a “disk” or a “disk drive” but the adaptive embodiments disclosed herein are not limited to any particular type of storage media/device.

The storage system 108 comprises one or more processor 112 (also referred to as a central processing unit), a memory 114, a network adapter 118 and a storage adapter 120 interconnected by an interconnect system (also referred to as a “bus system”) 116. In the illustrative embodiment, memory 114 comprises storage locations that are addressable by processor 112 and other modules, for example, storage adapter 120 and network adapter 118) for storing machine executable instructions.

Processor 112 may be, or may include, one or more programmable general-purpose or special-purpose microprocessors, digital signal processors (DSPs), programmable controllers, application specific integrated circuits (ASICs), programmable logic devices (PLDs), or the like, or a combination of such hardware based devices.

The bus system 116, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other interconnect type.

The network adapter 118 includes mechanical, electrical and signaling circuitry needed to connect the storage system 108 to one or more client systems 102 (shown as client 102) over a connection system 106 (also referred to as network 106), which may comprise a point-to-point connection or a shared medium, such as a local area network. Illustratively, connection system 106 may be embodied as an Ethernet network, a Fibre Channel (FC) network or any other network type. The client 102 may communicate with the storage system 108 via network 106 by exchanging discrete frames or packets 110 of data according to pre-defined protocols, such as the Transmission Control Protocol/Internet Protocol (TCP/IP) or any other protocol type.

Client 102 may be a general-purpose computer configured to execute processor executable applications 104. Moreover, client 102 may interact with the storage system 108 in accordance with a client/server model of information delivery. That is, the client may request the services of the storage system, and the system may return the results of the services requested by the client, by exchanging packets 110 over the network 106. The clients may issue packets including file-based access protocols, such as the Common Internet File System (CIFS) protocol or Network File System (NFS) protocol, over TCP/IP when accessing information in the form of files and directories. Alternatively, the client may issue packets including block-based access protocols, such as the Small Computer Systems Interface (SCSI) protocol encapsulated over TCP (iSCSI) and SCSI encapsulated over Fibre Channel Protocol (FCP), when accessing information in the form of blocks.

The storage adapter 120 cooperates with a storage operating system 200 executed by processor 112 to access information requested by a user (or client). The storage adapter 120 includes input/output (I/O) interface circuitry that couples to the storage devices over an I/O interconnect arrangement, such as a conventional high-performance, FC serial link topology.

The storage operating system 200 preferably implements a high-level module, such as a file system, to logically organize information as a hierarchical structure of data containers at storage devices 122. Storage operating systems 200, portions of which are typically resident in memory 114 and executed by the processing elements, functionally organizes the system 108 by, inter alia, invoking storage operations executed by the storage system.

Storage operating system 200 presents storage volumes to clients 102 for reading and writing data. The term storage volume or volume as used herein means a logical data set which is an abstraction of physical storage, combining one or more physical mass storage devices or parts thereof into a single logical storage object. However, each storage volume can represent the storage space in one storage device, an aggregate of some or all of the storage space in multiple storage devices, a RAID group, or any other set of storage space.

A storage volume is typically a collection of physical storage devices 122 cooperating to define an overall logical arrangement of volume block number (vbn) space on the volume(s). Each logical volume is generally, although not necessarily, associated with its own file system. The storage devices within a logical volume/file system are typically organized as one or more groups, wherein each group may be operated as a RAID.

To facilitate access to storage devices 122, in one embodiment, the storage operating system 200 implements a write-anywhere file system. The file system logically organizes information as a hierarchical structure of named data containers, e.g. directories and files. Each “on-disk” data container may be implemented as set of blocks configured to store information, such as data, whereas the directory may be implemented as a specially formatted data container in which names and links to other data containers and directories are stored.

In the illustrative embodiment, the storage operating system is preferably the NetApp® Data ONTAP™ operating system available from NetApp, Inc., Sunnyvale, Calif. that implements a Write Anywhere File Layout (WAFL™) file system (without derogation of any trademark rights of NetApp Inc. in NetApp®, ONTAP™, WAFL™ and other terms used herein). However, it is expressly contemplated that any appropriate storage operating system may be enhanced for use in accordance with the inventive principles described herein. As such, where the term “WAFL” is employed, it should be taken broadly to refer to any storage operating system that is otherwise adaptable to the teachings of this disclosure.

Although storage system 108 is shown as a stand-alone system, i.e. a non-cluster based system, in another embodiment, storage system 108 may have a distributed architecture that may include, for example, a separate N-(“network”) blade and D-(disk) blade. Briefly, the N-blade is used to communicate with client 102, while the D-blade is used to communicate with the storage devices 130 that are a part of a storage sub-system. The N-blade and D-blade may communicate with each other using an internal protocol. The term blade as used herein means a computing system, a processor based system, a module or any other similar system.

Alternatively, storage system 108 may have an integrated architecture, where the network and data components are all contained in a single enclosure. The storage system 108 further may be coupled through a switching fabric to other similar storage systems (not shown) which have their own local storage subsystems. In this way, all of the storage subsystems can form a single storage pool, to which any client of any of the storage servers has access.

Operating System 200:

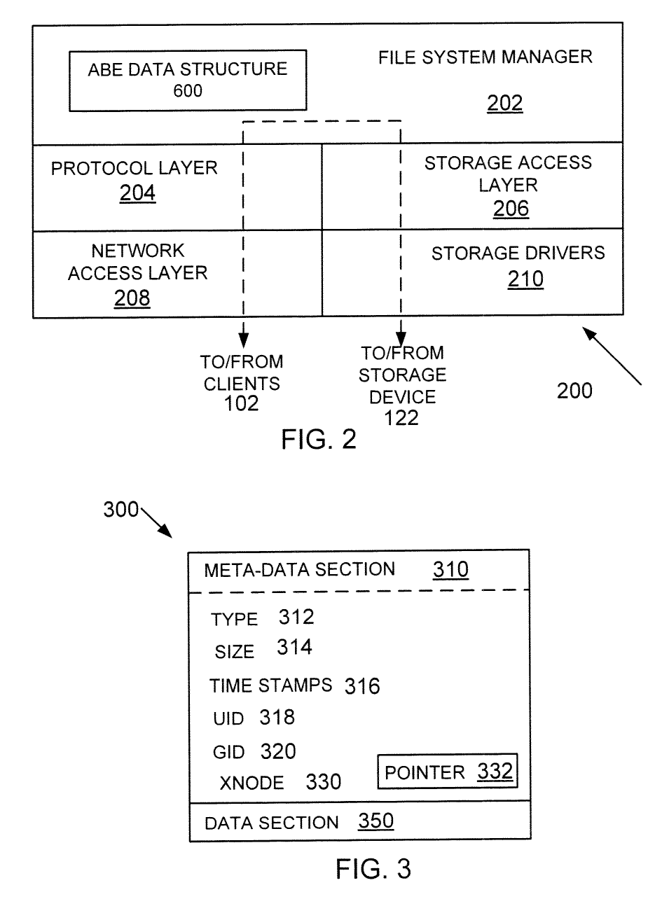

FIG. 2 illustrates a generic example of operating system 200 for storage system 108, according to one embodiment of the present disclosure. In one example, operating system 200 may be installed at storage system 108. It is noteworthy that operating system 200 may be used in any desired environment and incorporates any one or more of the features described herein.

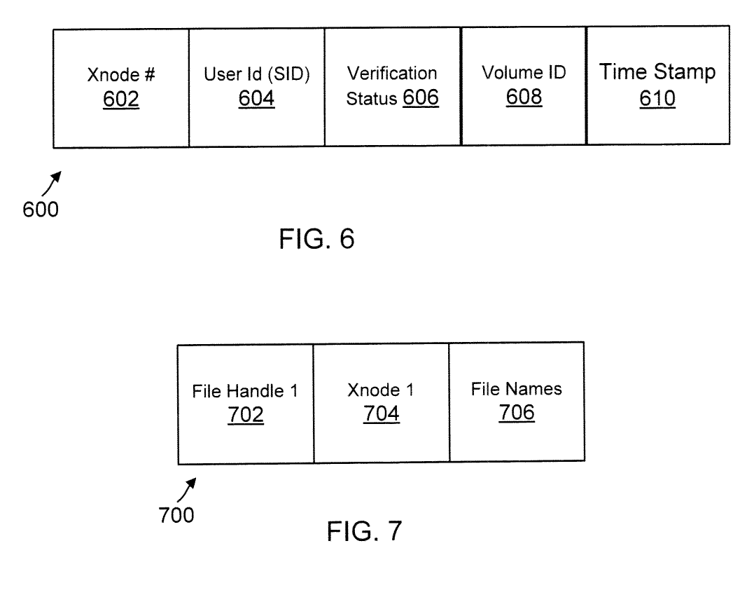

In one example, operating system 200 may include several modules, or hardware based, processor executable “layers”. These layers include a file system manager 202 that keeps track of a directory structure (hierarchy) of the data stored in storage subsystem 124 and manages read/write operations, i.e. executes read/write operations at storage devices 122 in response to client 102 requests. In one embodiment, file system 202 maintains an ABE data structure 600 that is described below in detail with respect to FIG. 6. The ABE data structure 600 is used for access based directory enumeration without having to load and use access control list (ACL) entries, once user credentials have been verified.

Operating system 200 may also include a protocol layer 204 and an associated network access layer 208, to allow storage system 108 to communicate over a network with other systems, such as clients 102. Protocol layer 204 may implement one or more of various higher-level network protocols, such as NFS, CIFS, Hypertext Transfer Protocol (HTTP), TCP/IP and others.

Network access layer 208 may include one or more drivers, which implement one or more lower-level protocols to communicate over the network, such as Ethernet. Interactions between clients 102 and mass storage devices 122 are illustrated schematically as a path, which illustrates the flow of data through operating system 200.

The operating system 200 may also include a storage access layer 206 and an associated storage driver layer 210 to allow storage system 108 to communicate with storage subsystem 124. The storage access layer 206 may implement a higher-level disk storage protocol, such as RAID (redundant array of inexpensive disks), while the storage driver layer 210 may implement a lower-level storage device access protocol, such as FCP or SCSI. In one embodiment, the storage access layer 206 may implement a RAID protocol, such as RAID-4.

It should be noted that the software “path” through the operating system layers described above needed to perform data storage access for the client request received at the storage system may alternatively be implemented in hardware. That is, in an alternate embodiment of the invention, the storage access request data path may be implemented as logic circuitry embodied within a field programmable gate array (FPGA) or an application specific integrated circuit (ASIC). This type of hardware implementation increases the performance of the file service provided by storage system 108 in response to a file system request packet 110 issued by client 102. Moreover, in another alternate embodiment of the invention, the processing elements of network and storage adapters (118, 120) may be configured to offload some or all of the packet processing and storage access operations, respectively, from processor 112 to thereby increase the performance of the file service provided by the storage system.

In one embodiment, file system manager 202 includes a WAFL layer. The WAFL based file system is block-based, i.e. stores information at storage devices as blocks, for example, using, e.g., 4 kilobyte (KB) data blocks, and using inodes to describe the files. An inode is a data structure, e.g., a 128-byte structure, which may be used to store information, such as meta-data, about a file. The meta-data may include data information, e.g., ownership of the file, access permission for the file, size of the file, file type and location of the file at storage device, as described below. The WAFL layer uses a file handle, i.e., an identifier that includes an inode number, to retrieve an inode from a storage device (122). The WAFL layer also uses files to store meta-data describing the layout of its file system. These meta-data files include, among others, an inode file.

Inode Structure:

FIG. 3 shows an example of an inode structure 300 (may also be referred to as inode 300) used according to one embodiment. Inode 300 may include a meta-data section 310 and a data section 350. The information stored in meta-data section 310 of each inode 300 describes a file and, as such, may include the file type (e.g., regular or directory) 312, size 314 of the file, time stamps (e.g., access and/or modification) 316 for the file and ownership, i.e., user identifier (UID 318) and group ID (GID 320), of the file. The metadata section 310 further includes an Xnode field 330 with a pointer 332 that references another on-disk inode structure having e.g., ACL information (or ACL entries) associated with the file or directory. ACL entries are used to allow or deny access to user to any stored data container. When a user is not allowed access to a data container, then during directory enumeration, an entry for the data container is not displayed to the user.

The contents of data section 350 of each inode 300 may be interpreted differently depending upon the type of file (inode) defined within the type field 312. For example, the data section 350 of a directory inode structure includes meta-data controlled by the file system, whereas the data section of a “regular inode” structure includes user-defined data. In this latter case, the data section 350 includes a representation of the data associated with the file.

Specifically, data section 350 of a regular on-disk inode file may include user data or pointers, the latter referencing, for example, 4 KB data blocks for storing user data at a storage device. Each pointer is preferably a logical volume block number to facilitate efficiency among file system 202.

Inode structure 300 may have a restricted size (for example, 128 bytes). Therefore, user data having a size that is less than or equal to 64 bytes may be represented, in its entirety, within the data section of an inode. However, if the user data is greater than 64 bytes but less than or equal to, for example, 64 kilobytes (KB), then the data section of the inode comprises up to 16 pointers, each of which references a 4 KB block of data stored at a storage device. Moreover, if the size of the data is greater than 64 kilobytes but less than or equal to 64 megabytes (MB), then each pointer in the data section 350 of the inode references an indirect inode that contains 1024 pointers, each of which references a 4 KB data block at storage device.

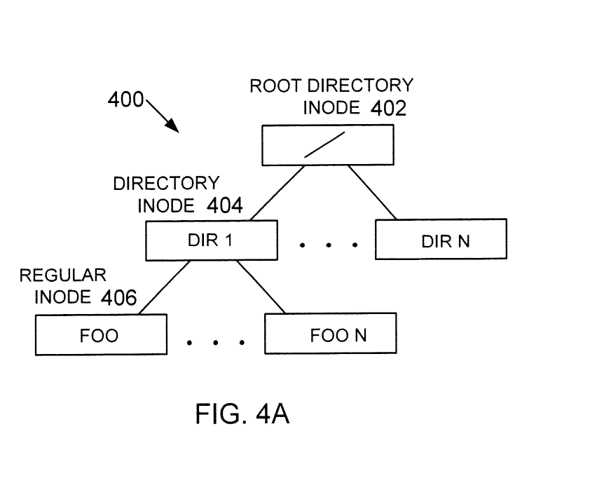

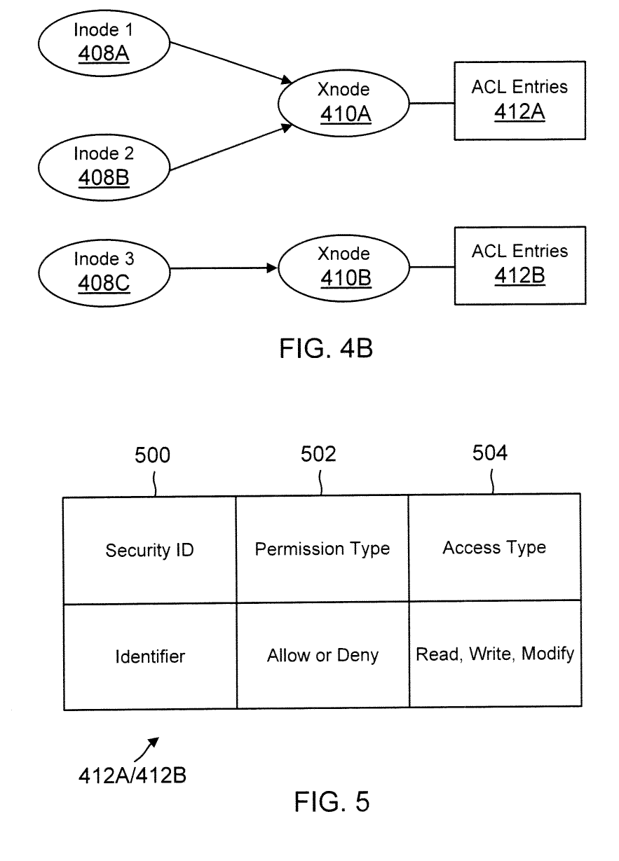

FIG. 4A is a schematic block diagram illustrating a hierarchical on-disk inode structure 400 used by file system 202. Specifically, the WAFL layer of file system manager 202 parses the first (/) preceding a pathname and maps it to a root inode structure 402 of its file system. The root inode 402 is a directory with a plurality of entries, each of which stores a name of a directory and its corresponding mapping file handle. Operating system 200 can convert that handle to a storage device block and, thus, retrieve a block (inode) from storage device.

Broadly stated, a name is an external representation of an inode data structure, i.e., a representation of the inode as viewed external to the file system. In contrast, the file handle is an internal representation of the data structure, i.e., a representation of the inode data structure that is used internally within the file system. The file handle generally consists of a plurality of components including a file ID (inode number) and a flag. The file handle is exchanged among the client 102 and storage system 108 over the network 106 to enable storage system 108 to efficiently retrieve a corresponding file or directory. That is, the file system manager 202 may efficiently access a file or directory by mapping its inode number to a block at storage device 122 using the inode file.

Accordingly, the WAFL layer loads a root directory inode 402 from storage device 122 into memory 114, such that the root inode is represented as an incore inode, and loads any data blocks referenced by the incore root inode. The WAFL layer then searches the contents of the root inode data blocks for a directory name, for example, “DIR1”. If the DIR1 directory name is found in those data blocks, the WAFL layer uses the corresponding file handle to retrieve the DIR1 directory inode 404 from storage device and loads it (and its data blocks) into memory as an incore inode structure(s). As with the root inode, the directory inode has a plurality of entries; here, however, each entry stores a name of a regular file and its corresponding mapping file handle.

The WAFL layer searches the entries of the DIR1 directory inode data blocks to determine whether a regular inode file name, for example, “FOO” exists and, if so, obtains its corresponding file handle (inode number) and loads the regular inode 406 from storage device 122. The WAFL layer then returns the file handle for the file name “FOO” to protocol layer (for example, CIFS layer) 204 of the operating system 200.

FIG. 4B shows an example of a directory that may have multiple entries. Each directory entry has an inode (for example, 408A, 408B and 408C). Each directory entry inode is associated with an Xnode (for example, 410A and 410B) that reference access control list (ACL) entries 412A/412B used for allowing or denying access. It is noteworthy that multiple inodes (408A/408B) may reference the same Xnode (for example, 410A).

An example of a typical directory is also shown below in Table I. The first column stores a file handle (i.e. an inode number) and the second column stores the file names corresponding to each directory entry.

TABLE I

| | |
|---|---|
| File Handle1 (inode num1) | File names |
| File Handle2 (inode num2) | File names |
| File Handle3 (inode num3) | File names |
| . . . | . . . |

FIG. 5 shows an example of an ACL entry, for example, 412A/412B. An ACL entry includes a security identifier 500 for identifying a group or a user (referred to as a user identifier). The permission type 502 indicates if the user is allowed or denied. The access type 504 indicates whether the user is permitted to read, write and/or modify a data container associated with a directory entry.

FIG. 6 shows a block diagram of a data structure 600 that is used for efficiently performing ABE, according to one embodiment. The data structure includes an Xnode identifier 602 that identifies the Xnode (for example, 410A and 410B) that is referenced by the directory entry inode (for example, 408A). The data structure includes a user identifier (or user security identifier (SID)) 604 and status indicator 606 indicating if the user was allowed or denied permission with respect to the Xnode identifier.

The data structure 600 may also include a volume ID 608 and a time stamp entry 610. The time stamp may be used to time out old entries, as described below in detail.

The following shows an example for implementing data structure 600 as a record stash. The stash is used to record the results of user credential checks against an Xnode. The stash state may be created and maintained during directory enumeration.

```
struct {
  uint32_t ACL_inode_num[SIZE];
  uint8_t result[SIZE];
  uint16_t cursor;
  unit8_t num_entries;
} stash;
```

In one embodiment, the foregoing stash may be constructed each time a request for directory enumeration is received. The stash is advantageous for each enumeration request because many entries in a directory refer to the same Xnode, as explained by the example below.

Assume that a Directory “X” has the following entries for File1 to File 10000:

### File1::Xnode 123

### File2::Xnode 123

### File3::Xnode 123

### File4::Xnode 500

### File5::Xnode 500

### File6::Xnode 123

### File7::Xnode 123

### File8::Xnode 2000

File9 through File 10000: Xnode 500
Assume that:
Xnode 123 grants access to a user “tom” (among others)
Xnode 500 denies all access to the user “tom”
Xnode 2000 grants access to user “tom”

So when user “tom” issues a request to enumerate directory X, only File1, File2, File3, and File8 should be returned. Now assume each Xnode has about 250 ACL entries. To determine if “tom” can see an entry, in conventional systems, the credentials associated with “tom” is inspected for each ACL entry, in each Xnode associated with each directory entry. This is time consuming and laborious. With the embodiments of this disclosure, the system only checks each Xnode once, saving numerous lookups.

In the foregoing example, assume that Xnode 500 has 300 ACL entries, but nothing in any of them grant any rights to user tom. In conventional systems, the system would have to examine 10000*300=3,0000,000 ACL entries whenever directory X is enumerated, even though tom is denied for each entry. With the embodiments described herein, after File4 is examined, the system remembers that Xnode 500 does not grant access, so when completing the enumeration, the check for each file is not performed. This saves a lot of time and resources, especially for directories that may have millions of entries, and ACLs that may have hundreds of ACL entries, and most if not all entries in a directory have the same Xnode.

In another embodiment, a second stash structure may be used where the results of a first enumeration are stored for future use. An example of the second structure is provided below:

```
struct _stash {
struct _hashkey {
  SID owner_id;
  Volume_t  volume_id;
} hashkey;
struct {
    inum_t Xnode_num;
    gen_t Xnode_generation;
    bool  access_ok;
} results[SIZE] _PACKED;
int  cursor;
int  num_entries;
Timestamp_t insert_time;
Cred_cache_gen owner_cred_cache_generation;
struct _stash * fwdhashlink;
struct _stash * bwdhashlink;
```

In the second stash structure, an Xnode generation number may be used to invalidate any stash entries that may refer a different security descriptor. The time stamp value may be used to time out old entries.

In one embodiment, for the second stash structure, the data structure 600 is populated when a directory is enumerated for the first time and Xnode numbers for file handles are known. For future directory enumerations, data structure 600 can be used to look up Xnode numbers corresponding to a file handle.

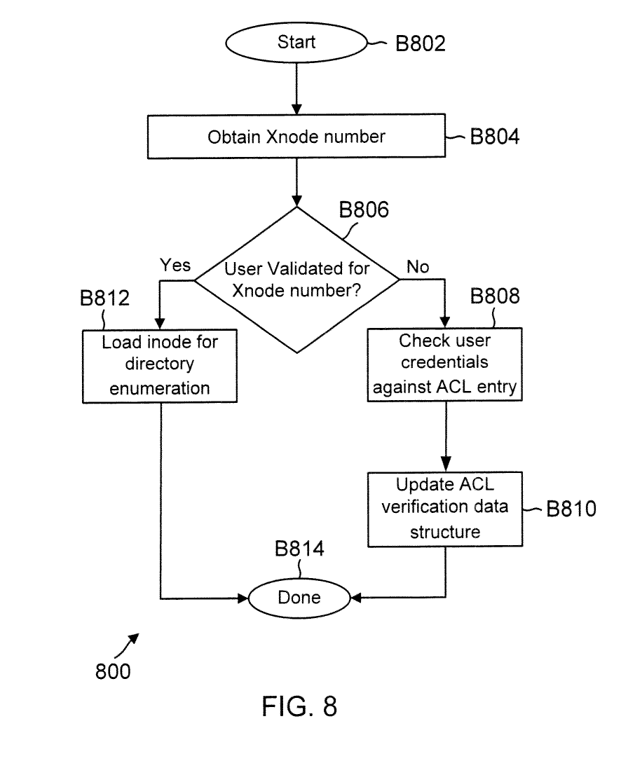

When an Xnode number for a file changes, then the corresponding entry at data structure is deleted and populated with a new Xnode number. Entries from data structure 600 are also deleted when a file is deleted. The process for using the data structure 600 is described below with respect to FIG. 8.

FIG. 7 shows an example of modifying directory entries shown in Table I above. The modified directory entry 700 includes a file handle 702 (i.e. an inode number), an Xnode number 704 and the file names 706 for the inode 702. Table 2 shows an example of modified directory entries, according to one embodiment.

TABLE II

| | | |
|---|---|---|
| File Handle1 (inode num1) | ACL inode1 | File names |
| File Handle2 (inode num2) | ACL inode1 | File names |
| File Handle3 (inode num3) | ACL inode2 | File names |
| . . . | . . . | . . . |

The modified directory entries can be used to efficiently obtain the Xnode identifier values during a directory enumeration state, as described below in detail.

FIG. 8 shows a process 800 for ABE, according to one embodiment. The process begins in block B802, when a user request to enumerate a directory having a plurality of entries is received.

In block B804, the file system 202 obtains the Xnode number for a directory entry. The Xnode number may be obtained from the directory entry as shown above with respect to FIG. 7. If the directory entry does not have the Xnode number, then the inode for the directory entry is loaded into memory 114 and the Xnode number (330, FIG. 3) is obtained from the inode.

In block B806, the file system 202 verifies to determine if user credentials have been verified using data structure 600 described above.

If user credentials have not been verified, then in block B808, the user credentials are verified by an ACL entry referenced by the Xnode. In block B810, data structure 600 is updated so that user credentials for future enumeration requests can be validated, without having to load the ACL entry and the process is completed in block B814.

If user credentials were validated before, then the inode for the directory entry is loaded for enumeration in block B812 based on whether the user is allowed or denied access. When the user is allowed, the directory entry is provided to the user during enumeration, otherwise access is denied. Thereafter, the process ends in block B814.

The embodiments disclosed above have advantages over conventional ABE techniques. Repetitive checking of user credentials against ACL entries is avoided by using the data structure 600. One does not have to load the inodes of directory entries in memory, which saves processing time and resources.

Thus, a method and apparatus for performing access based enumeration is provided. Note that references throughout this specification to “one embodiment” or “an embodiment” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics being referred to may be combined as suitable in one or more embodiments of the disclosure, as will be recognized by those of ordinary skill in the art.

While the present disclosure is described above with respect to what is currently considered its preferred embodiments, it is to be understood that the disclosure is not limited to that described above. To the contrary, the disclosure is intended to cover various modifications and equivalent arrangements within the spirit and scope of the appended claims.

What is claimed is:

1. A machine implemented method for performing access based enumeration for a directory having a plurality of directory entries corresponding to a plurality of data containers stored at a storage device managed by a storage system, comprising:
obtaining a block identifier that references an access control entry used for allowing or denying access to a user to a data container corresponding to a directory entry;
verifying using a data structure if a previous user request associated with the block identifier has been validated; wherein the data structure stores the block identifier, a user identifier and a status indicating whether the user request was allowed or denied; and
presenting the directory entry for the data container, when the user was has been validated.

2. The method of claim 1, further comprising:
verifying a user credential using an access control entry referenced by the block identifier, when the user has not been previously validated using the access control entry; and
updating the data structure indicating that the user has been validated.

3. The method of claim 1, wherein the block identifier identifies an Xnode that references a location for storing an access control entry that stores permission information to allow or deny access to the user to a particular data container.

4. The method of claim 4, wherein the block identifier is stored within a metadata for the inode for the directory entry.

5. The method of claim 1, wherein the block identifier information is obtained from the directory entry that also stores a file handle identifying an inode and file names.

6. A machine implemented method for performing access based enumeration (ABE) for a directory having a plurality of directory entries corresponding to a plurality of data containers stored at a storage device managed by a storage system, comprising:
maintaining a data structure for tracking user credential validation for accessing the plurality of data containers; and
instead of loading an access control entry from a storage location for every ABE operation for the directory, using the data structure to present a directory entry to a user when user credentials for the directory entry have been validated and recorded in the data structure.

7. The method of claim 6, further comprising:
verifying user credentials using an access control entry referenced by a block identifier, when the user credential have not been previously validated as indicated by the data structure; and
updating the data structure indicating that the user has been validated.

8. The method of claim 7, wherein the block identifier identifies an Xnode that references a location for storing the access control entry that stores permission information to allow or deny access to the user.

9. The method of claim 7, wherein the block identifier is stored within a metadata for an inode for the directory entry.

10. The method of claim 7, wherein the block identifier information is obtained from a directory entry that also stores a file handle identifying an inode.

11. A storage system, comprising:
a plurality of storage devices storing a plurality of data containers; and
a processor executing a storage operating system for performing access based enumeration for a directory having a plurality of directory entries corresponding to the plurality of data containers;
wherein the storage operating system obtains a block identifier that references an access control entry used for allowing or denying access to a user to a data container corresponding to a directory entry; verifies using a data structure if a previous user request associated with the block identifier has been validated, where the data structure stores the block identifier, a user identifier and a status indicating whether the user request was allowed or denied; and presents the directory entry for the data container, when the user was has been validated.

12. The storage system of claim 11, wherein the storage operating system is configured to verify user credentials using an access control entry referenced by the block identifier, when the user has not been previously validated using the access control entry; and updates the data structure indicating that the user has been validated.

13. The storage system of claim 11, wherein the block identifier identifies an Xnode that references a location for storing an access control entry that stores permission information to allow or deny access to the user to a particular data container.

14. The storage system of claim 13, wherein the block identifier is stored within a metadata for the inode for the directory entry.

15. The storage system of claim 11, wherein the block identifier information is obtained from the directory entry that also stores a file handle identifying an inode and file names.

16. A storage system, comprising:
a plurality of storage devices storing a plurality of data containers; and
a processor executing a storage operating system for performing access based enumeration for a directory having a plurality of directory entries corresponding to the plurality of data containers;
wherein the storage operating system maintains a data structure for tracking user credential validation for accessing the plurality of data containers; and instead of loading an access control entry from a storage location for every ABE operation for the directory, uses the data structure to present a directory entry to a user when user credentials for the directory entry have been validated and recorded in the data structure.

17. The system of claim 16, wherein when the user credential have not been previously validated as indicated by the data structure, then user credentials are verified using an access control entry referenced by a block identifier; and the data structure is updated to indicate that the user has been validated.

18. The system of claim 17, wherein the block identifier identifies an Xnode that references a location for storing the access control entry that stores permission information to allow or deny access to the user.

19. The system of claim 17, wherein the block identifier is stored within a metadata for an inode for the directory entry.

20. The system of claim 17, wherein the block identifier information is obtained from a directory entry that also stores a file handle identifying an inode.
